(19) United States
(12) Patent Application Publication
(10) Pub. No.: US 2006/0066835 A1
(43) Pub. Date: Mar. 30, 2006

(54) Method for operating an electronic viewing system and vehicle comprising an electronic viewing system

(76) Inventors: Martin Laufer, Hasloch (DE); Christian Schmidt, Erfurt (DE); Tim Weis, Mainaschaff (DE)

Correspondence Address: MCGLEW & TUTTLE, PC, P.O. BOX 9227, SCARBOROUGH STATION, SCARBOROUGH, NY, 10510-9227, US

(21) Appl. No.: 11/238,235

(22) Filed: Sep. 29, 2005

(30) Foreign Application Priority Data
Sep. 30, 2004 (DE) 10 2004 048 185.7

(51) Int. Cl. G01C 3/00

(52) U.S. Cl. 356/3

(57) ABSTRACT

A method and a device for operating an electronic viewing system (11) of a vehicle, which viewing system (11) allowing the driver to view the claimed travel way or soon to be occupied travel path. The system uses at least two optical sensors (01), an image display unit (10), and a detector device (03), wherein by means of the detector device (03) the motion state of the vehicle can be detected. The selection of the images which are shown on the image display unit (10) and which are generated by the optical sensors (01) can be made dependent on the motion state of the vehicle.

### CROSS REFERENCE TO RELATED APPLICATIONS

This application claims the benefit of priority under 35 U.S.C. § 119 of German Application DE 10 2004 048 185.7 filed Sep. 30, 2004, the entire contents of which are incorporated herein by reference.

### FIELD OF THE INVENTION

The invention relates to a method for operating an electronic viewing system of a vehicle and to a vehicle with an electronic viewing system.

### BACKGROUND OF THE INVENTION

When operating vehicles in public traffic situations, as a rule, from their positions, drivers are unable to see all the regions surrounding their vehicle. However, as is well known, when using rear-view mirrors as an aid in viewing these regions, so-called blind angles occur. Such blind angles, in particular the rear side regions and the rear region, cannot be viewed from the driver's position.

In order to make it possible to view such regions, the arrangement of a multitude of individual cameras on the outside of a vehicle is known from DE 100 37 129 A1. It is proposed, preferably, to arrange one camera in each of the four corners of the vehicle. However, this does not make it possible to allow simultaneous, distortion-free and complete viewing of all the regions, including regions which are situated very close to the vehicle.

Furthermore, this printed publication proposes, depending on the selected steering angle or from a distance sensor, to overlay the respective camera image which is relevant at a given time. However, this sensor arrangement is unsuitable for achieving a viewing system which only displays image information which is required to view the travel way which is claimed in the respective situation. For example, this sensor arrangement cannot detect any reversing motion and furthermore cannot differentiate between an overtaking maneuver and driving along a curve.

### SUMMARY OF THE INVENTION

It is thus the object of the present invention to provide a new method for operating an electronic viewing system of a vehicle, and a new vehicle with an electronic viewing system.

To meet this objective, the invention provides a method for operating an electronic viewing system of a vehicle, which viewing system allows the driver to view the claimed travel way, comprising at least two optical sensors, in particular video cameras, an image display unit, in particular a display screen, and a detector device. The images generated by the optical sensors can be shown, as a selection or jointly, on the image display unit, and wherein by means of the detector device the motion state of the vehicle can be detected, and wherein detection of the motion state takes place by means of at least one vehicle speed sensor and/or by means of a gear state sensor for detecting the direction of travel of the vehicle, and wherein the selection of the images which are shown on the image display unit and which are generated by the optical sensors can be made dependent on the motion state of the vehicle.

The viewing system allows the driver to view the claimed travel way. The term “claimed travel way” refers to that area of the traffic space which the vehicle will claim in the near future (this is also referred to herein as the soon to be occupied travel path or expected travel way). This claimed travel way can be determined by way of monitoring suitable characteristics of the vehicle steering system. In order to ensure collision-free movement of the vehicle the claimed travel way should be free of any obstacles. This can, for example, be ensured by the driver viewing the claimed travel way.

According to the invention, viewing takes place by way of optical sensors, in particular video cameras. These video cameras monitor the traffic space which surrounds the vehicle, wherein the images from said video cameras can be represented, jointly or as a selection, on an image display unit, in particular on a display screen.

In most traffic situations there is no need to display the entire traffic space that surrounds the vehicle on the one image display unit. This would in fact constitute a hazard, because, during driving, drivers themselves need to select the information important to them. It is thus expedient to detect the motion state of the vehicle by means of a suitable detector device, and subsequently to have the image display unit show only a selection of the images generated by the optical sensors, which selection depends on the motion state of the vehicle. In this process, expediently that image information is selected which shows the claimed travel way. Images with irrelevant information are not shown. In this way the attention of drivers is not taken up unnecessarily.

The detector device should reliably make it possible to detect all relevant motion states of the vehicle. To this effect, said detector device comprises various sensors for detecting important vehicle parameters. The sensors should make it possible to measure vehicle speed. In this way it is for example possible to differentiate between driving along a curve and overtaking maneuvers. Furthermore, the detector device should comprise a gear state sensor for detecting the direction of travel of the vehicle. In this way, reversing can reliably be detected. Furthermore, a sensor for detecting the state of a direction indication device, in particular of the turn signal indicators, and a sensor for detecting the steering angle of the steering device are useful supplements. If the vehicle is operated with a trailer, the angular position of the trailer relative to the towing vehicle can be detected by means of a further sensor.

A special embodiment of the method can for example be such that first the motion state of the vehicle is continuously detected by means of the detector device. In this arrangement the detector device uses the individual sensors for determining the parameters of the vehicle. Possible motion states of the vehicle can for example include fast or slow lane change to the left or right, driving forward in a curve to the left or right, reversing in a curve to the left or right, or starting from rest and moving straight, either forward or in reverse.

Slow and fast lane change to the left or right can for example be detected by way of the vehicle speed and by way of monitoring a direction indicating device, in particular by way of the turn signal indicators. Detection of driving forward or in reverse in a curve to the left or right can for example be by way of the steering angle of the steering device, by way of monitoring the gear state sensor, by way of the vehicle speed, and if the vehicle is operated with a trailer additionally by way of the angular position of the trailer relative to the vehicle. Detection of a start from rest, straight, either forward or in reverse, can take place by way of monitoring the gear state, the vehicle speed, and if necessary additionally by way of the steering angle of the steering device.

After the motion state of the vehicle has been detected by means of the detector device, depending on this movement state, a selection of the images generated by the optical sensors is made continuously. The selection comprises precisely those images which are typically required for the driver to view the claimed travel way.

The selection of images can either be a selection of entire images or a selection of partial images, in particular of frames. In principle it does not matter where in the viewing system the selection is made. Thus either all of the images generated by the optical sensors can be forwarded to the image display unit or to a selection unit, in order to make a selection therein, or only those images and/or frames generated by the optical sensors can directly or indirectly be forwarded to the image display unit which images and/or frames are to be displayed in a situation-related context depending on the motion state of the vehicle.

After the situation-dependent selection has been made, this image selection is shown on the image display unit.

In a further independent embodiment for obtaining individual influencing, for example in the case of problems or malfunctions of the detector device, it has been proposed that the selection be carried out manually by the driver. To this effect, all the images generated by the optical sensors can simultaneously be displayed on a display screen in an overview, in particular in the form of so-called thumbnails, from where they can manually be incorporated into the selection by the driver.

The vehicle according to the invention, comprising an electronic viewing system for allowing the driver to view the claimed travel way, comprises a multitude of optical sensors, in particular six video cameras and an image display unit, in particular a display screen, wherein the images generated by the optical sensors can be shown on the image display unit as a selection or jointly. Expediently, the image display unit is arranged in the field of view of the driver in his/her driving position. To this effect it is for example also possible to use an image display unit of a navigation device.

In principle, any desired design and arrangement of the optical sensors is possible. Expediently, they should however be of such a type and arrangement that any angle of view can be covered with them, including those regions of the traffic space which surround the vehicle, which regions are situated close to the vehicle. Furthermore, the optical sensors should not cause any excessive distortion. Such distortion may result in incorrect rendering of the size relationships and would invite the risk of further dangers as a result of driver misjudgment.

According to the invention, at least one optical sensor is arranged in the middle region of the front and the rear of the vehicle and near the four vertical outside edges on the right and left outside of the vehicle. In this arrangement, the optical sensors can also in each case be installed either at the top of or low down on the vehicle.

In this arrangement of the six optical sensors, almost distortion-free recording of the entire traffic space surrounding the vehicle can be ensured by the use of conventional video cameras with wide-angle lenses having a lens aperture angle of approximately 120°.

Using lenses with aperture angles of approximately 120°, arranging a video camera as an optical sensor in each of the four corners of a vehicle would, in contrast to the arrangement of six video cameras as described above, not make it possible to view every angle of the traffic space that surrounds the vehicle. Such an arrangement would necessitate the use of cameras with a lens aperture angle of significantly more than 120°, which would result in distorted reproduction of the traffic space 30 surrounding the vehicle.

In a further embodiment the vehicle comprises a detector device, wherein by means of the detector device the motion state of the vehicle is detectable. This detector device can for example be required in an automatic process as described above which makes it possible to detect the vehicle parameters required for determining the motion state of the vehicle.

To this effect the detector device can comprise a vehicle speed sensor, a sensor for detecting the state of a direction indication device, in particular of the turn signal indicators, a sensor for detecting the steering angle of the steering device, a gear state sensor for detecting the direction of travel of the vehicle, and/or a sensor for detecting the angular position of the trailer relative to the towing vehicle, in cases where the vehicle is operated with a trailer. Furthermore, full reference is made to the above explanations relating to the detector device.

In principle, attachment of the optical sensors, in particular of the optical sensors of the rear region of the vehicle, can be as desired. In smaller vehicles, in particular passenger motor vehicles, fixed installation of the optical sensors is advantageous from the point of view of their being secure from theft. However, in particular in the case of trucks and articulated trucks, fixed installation can have considerable disadvantages. For example, the optical sensors of the rear region of a vehicle, in particular of a semi-trailer or trailer, cannot simply be installed on another vehicle.

A further embodiment therefore proposes that the optical sensors of the rear region of a vehicle are removably connectable, by rotation, in a common holding device, wherein said holding device is attachable to the rear region of the vehicle. In this way it becomes possible to connect a group of optical sensors by means of a common holding device and for example to transport, reinstall and retrofit this group as a whole.

In this arrangement, for example, an installation rail which comprises attachment mechanisms can be used, which on the one hand can be attached to the rear of the vehicle, and on the other hand makes it possible to attach the rearward optical sensors. The installation rail can be attached to the rear of the vehicle, or detached from it together with the optical sensors, for example for the purpose of transport, renewed installation or retrofitting.

In a further advantageous embodiment, the holding device can comprise a fan-in device, wherein by means of the fan-in device the data of the individual optical sensors can be brought together such that the data that has been brought together can be transmitted by way of a transmission channel.

This additionally simplifies the installation of the viewing system since only a single transmission channel becomes necessary for all rearward optical sensors. Transmission can for example take place via a line in the LVDS or Firewire format, or using wireless technology, for example in Bluetooth 2.0 format.

Below, various embodiments of the method according to the invention as well as a viewing system suitable for implementing the method according to the invention are explained by way of examples. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a functional diagram of a first embodiment of the viewing system;

FIG. 2 is a top view of a second embodiment of the viewing system on an articulated truck;

FIG. 3 is a lateral view of the viewing system according to FIG. 2;

FIG. 4 is a front view of the viewing system according to FIG. 2;

FIG. 5 is a top view of the coverage of the traffic space which surrounds the articulated truck by the individual video cameras of the viewing system according to FIG. 2; and

FIG. 6 is a holding device for attaching the rearward video cameras to the vehicle.

### DESCRIPTION OF THE PREFERRED EMBODIMENTS

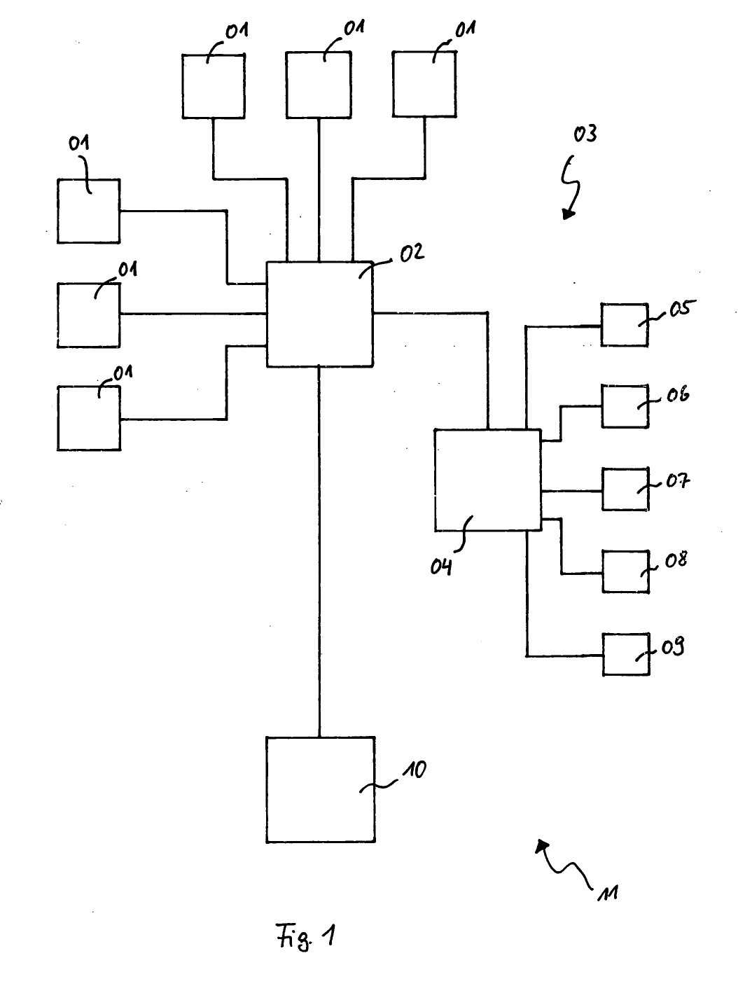

Referring to the drawings in particular, The viewing system 11 according to FIG. 1 comprises six video cameras 01 as optical sensors as well as a selection unit 02. Furthermore, the viewing system 11 comprises a detector device 03 with a computing unit 04 and various sensors 05 to 09 for measuring several vehicle parameters. The sensors are: a vehicle speed sensor 05, a gear state sensor 06 for detecting the direction of travel of the vehicle, a sensor 07 for detecting the state of the turn signal device, a sensor 08 for detecting the steering angle of the steering device, and a sensor 09 for detecting the angular position of the semi-trailer relative to the towing vehicle. Furthermore, the viewing system comprises a display screen 10 as an image display unit.

First of all, the detector device 03 is used to detect the motion state of the vehicle. To this effect, the detector device 03 uses the various sensors 05 to 09. In the embodiment shown, evaluation of the measurements obtained by the sensors 05 to 09 takes place in the computing unit 04. The result is conveyed to the selection unit 02.

The individual images of the video cameras 01 are also conveyed to the selection unit 02. The selection unit 02 selects the images and/or frames of the video cameras 01, which images and/or frames are relevant to the detected motion state, and then directly or indirectly conveys only this partial quantity to the display screen 10. All the other images which are irrelevant to the respective motion state are not conveyed onward.

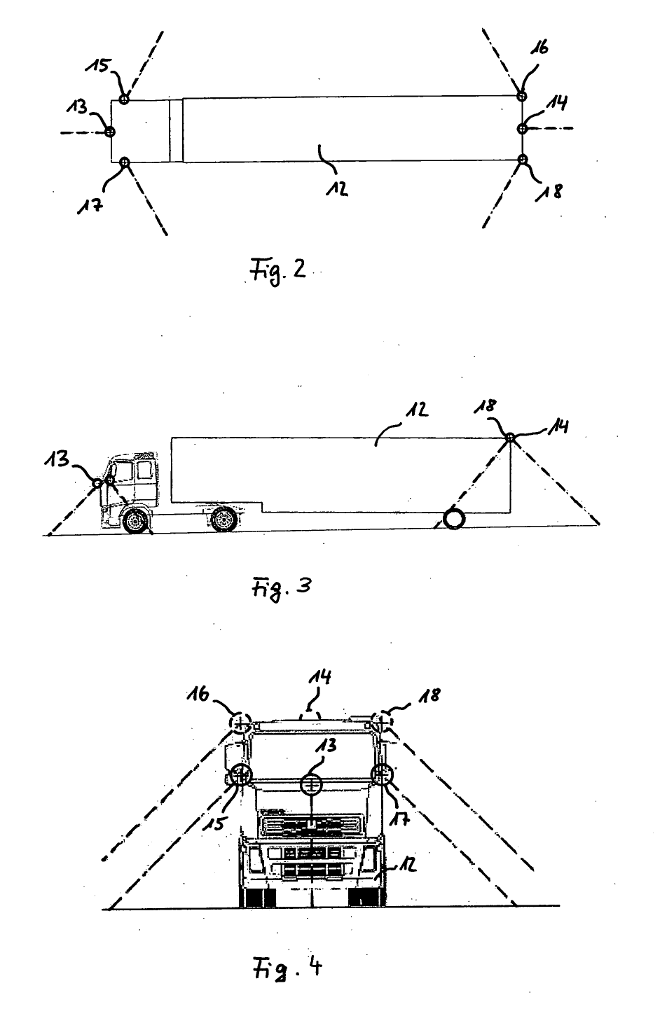

FIGS. 2 to 4 show three different views of the viewing system according to the invention in use in an articulated truck 12. The viewing system comprises six video cameras 13 to 18. The first video camera 13 is arranged in the middle region of the front of the articulated truck 12, below the windscreen. The second video camera 14 is arranged in the middle region of the rear of the articulated truck 12, at the top of the vehicle. The third video camera 15 is arranged on the right of the articulated truck 12 near the front vertical outside edge, at the rear-view mirror holding device. The fourth video camera 16 is arranged on the right outside of the articulated truck 12 near the rear vertical outside edge, in the upper region of the vehicle. The fifth video camera 17 is arranged on the left outside of the articulated truck 12 near the front vertical outside edge, at the rear-view mirror holding device. The sixth video camera 18 is arranged on the left outside of the articulated truck 12 near the rear vertical outside edge of the vehicle, at the top.

The arrangement of the individual video cameras 13-18 is not variable. The first video camera 13 faces directly forward, the second video camera 14 directly rearward, the third video camera 15 to the right rear, the fourth video camera 16 to the right front, the fifth video camera 17 to the left rear, and the sixth video camera 18 to the left front. This arrangement of the six video cameras results in complete and gapless coverage of the traffic space surrounding the vehicle—including those regions which are situated close to the vehicle.

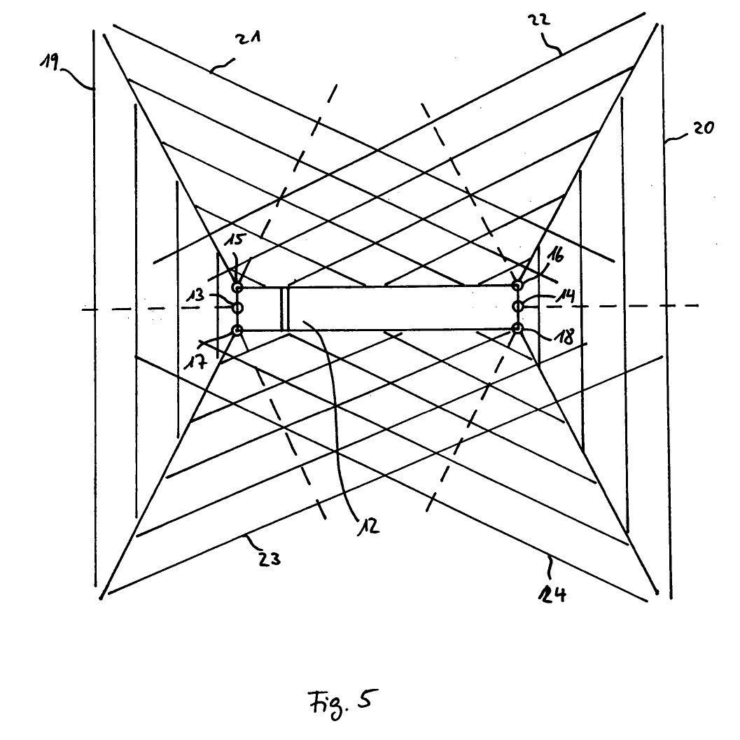

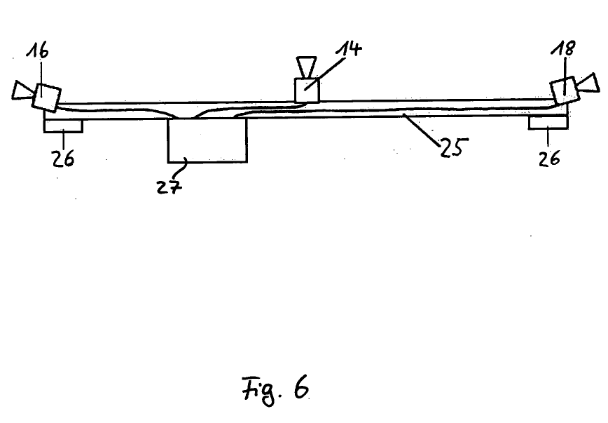

FIG. 5 shows this complete and gapless coverage of the entire traffic space which surrounds the vehicle through the fields of view 19 to 24 of the individual video cameras 13 to 18.

With the use of wide-angle lenses, each field of view 19-24 has an approximate aperture angle of 120°. The fields of view 19-24 are indicated by lines extending perpendicularly to the axis of view.

FIG. 6 shows a holding device 25 for attaching the rearward video cameras 14, 16, 18. The video cameras 14, 16, 18 are removably connectable, by rotation, to the holding device 25. With the use of an attachment means 26, the holding device 25 can be attached to the rear in the upper region of the articulated truck 12, so as to be horizontally aligned.

Furthermore, the holding device 25 comprises a feed unit 27 to which the image data of the video cameras 14, 16, 18 are conveyed. From the fan-in device 27, the image data can be conveyed to their destination by way of a single transmission channel.

While specific embodiments of the invention have been shown and described in detail to illustrate the application of the principles of the invention, it will be understood that the invention may be embodied otherwise without departing from such principles.

What is claimed is:

1. A method for operating an electronic viewing system of a vehicle, which viewing system allows the driver to view a claimed travel way, the method comprising:
providing the system with at least two optical sensors including video cameras, an image display unit with a display screen, and a detector device;
showing the images generated by the optical sensors on the image display unit, either based on a selection of one or jointly;
detecting, by means of the detector device, the motion state of the vehicle, wherein detection of the motion state takes place by means of at least one vehicle speed sensor and/or by means of a gear state sensor for detecting the direction of travel of the vehicle;
allowing the selection of the images which are shown on the image display unit and which are generated by the optical sensors to be made dependent on the motion state of the vehicle.

2. The method according to claim 1, wherein detection of the motion state of the vehicle takes place by means of at least one sensor for detecting the state of a direction indication device, in particular of the turn signal indicators, and/or by means of a sensor for detecting the steering angle of the steering device.

3. The method according to claim 1, wherein detection of the motion state of the vehicle, comprising a trailer, takes place at least by way of a sensor for detecting the angular position of the trailer relative to the vehicle.

4. The method according to claim 1, wherein:
first the motion state of the vehicle is continuously detected by means of the detector device;
subsequently, based on the detected motion state of the vehicle, a selection of the images generated by the optical sensors is made continuously, wherein the selection comprises precisely those images which are typically required for the driver to view the claimed travel way; and
thereafter the image selection is continuously shown in the image display unit.

5. A vehicle including an electronic viewing system for allowing the driver to view the expected travel way, the system comprising:
a multitude of optical sensors including six video cameras with at least one of said optical sensors arranged in a middle region of a front and a middle region of a rear of the vehicle and near each of four vertical outside edges on the right and the left outside of the vehicle, such that any angle of the traffic space surrounding the vehicle can be viewed; and
an image display unit with a display screen, wherein the images generated by the optical sensors can be shown on the image display unit jointly and can be shown on the image display unit as an individual selected view.

6. The vehicle according to claim 5, wherein the optical sensors are video cameras with wide-angle lenses, wherein the aperture angle of the wide-angle is approximately 120 degrees.

7. The vehicle according to claim 5, further comprising a detector device on the vehicle, wherein by means of the detector device the motion state of the vehicle is detected.

8. The vehicle according to claim 7, wherein the detector device comprises a vehicle speed sensor.

9. The vehicle according to claim 7, wherein the detector device comprises a gear state sensor for detecting the direction of travel of the vehicle.

10. The vehicle according to claim 7, wherein the detector device comprises a sensor for detecting the state of a direction indication device including the turn signal indicators.

11. The vehicle according to claim 7, wherein the detector device comprises a sensor for detecting the steering angle of the steering device.

12. The vehicle according to claim 5, the vehicle further comprising a cab and a trailer, wherein the detector device comprises a sensor for detecting the angular position of the trailer relative to the cab.

13. The vehicle according to claim 5, wherein the optical sensors of the rear region of the vehicle are removably connectable, by rotation, in a common holding device, wherein said holding device is attachable to the rear region of the vehicle.

14. The vehicle according to any one of claims 13, where the holding device comprises a fan-in device, wherein by means of the fan-in device the data of the individual optical sensors can be brought together such that the data that has been brought together can be transmitted by way of a transmission channel.

15. The vehicle according to claim 5, wherein the data of the individual optical sensors and/or the data brought together is transmitted using wireless technology.

16. An electronic viewing system of a vehicle, the system comprising:
two video cameras;
an image display unit with a display screen;
a detector device for detecting the motion state of the vehicle, wherein detection of the motion state takes place by means of at least one vehicle speed sensor and/or by means of a gear state sensor for detecting the direction of travel of the vehicle;
a control for showing the images generated by the optical sensors on the image display unit, either based on a selection of one or jointly, the control allowing for a selection of the images which are shown on the image display unit and which are generated by the optical sensors to be made dependent on the motion state of the vehicle to allow the driver to view a soon to be occupied travel path.

17. The system according to claim 16, wherein detection of the motion state of the vehicle takes place by means of a sensor for detecting the state of a turn signal indicator, and/or by means of a sensor for detecting the steering angle of the steering device.

18. The system according to claim 16, wherein detection of the motion state of the vehicle, comprising a truck and trailer, takes place at least by way of a sensor for detecting the angular position of the trailer relative to a vehicle truck.

19. The system according to claim 16, wherein said controller operates by:
first continuously detecting, by means of the detector device, the motion state of the vehicle;
subsequently, based on the detected motion state of the vehicle, selecting the images generated by the optical sensors continuously, wherein the selection comprises selecting those images which are typically required for the driver to view the soon to be occupied travel path; and
showing the selected image in the image display unit.
